(19) United States
(12) Patent Application Publication
(10) Pub. No.: US 2011/0106637 A1
(43) Pub. Date: May 5, 2011

(54) PROGRAM, INFORMATION PROCESSING APPARATUS, INFORMATION PROCESSING METHOD, AND INFORMATION MANAGEMENT APPARATUS

(76) Inventors: Norio Goto, Tokyo (JP); Takeshi Shika, Chiba (JP)

(21) Appl. No.: 12/996,689

(22) PCT Filed: Jun. 12, 2008
(86) PCT No.: PCT/JP2008/060746

§ 371 Date: Dec. 7, 2010

(51) Int. Cl. G06Q 30/00

(52) U.S. Cl. 705/14.73; 705/14.4

(57) ABSTRACT

The present invention relates to a program, an information processing apparatus, an information processing method, and an information management apparatus capable of increasing the probability that the user browsing WEB pages views an advertisement. A list 12A working in conjunction with the display of a WEB browser displays, as items, titles of WEB pages searched by a search server and advertisements selected according to the search result. If the start of slide show display is instructed when “WEB Page #1” is focused, “WEB Page #2”, “Advertisement #1”, “WEB Page #3”, “WEB Page #4”, “WEB Page #5”, “Advertisement #2”, . . . are sequentially focused, and the focused WEB pages are displayed on a WEB page display unit of the WEB browser. When “Advertisement #1” is focused, a WEB page linked from “Advertisement #1” and including detailed content of “Advertisement #1” is displayed. The present invention can be applied to a personal computer.

### TECHNICAL FIELD

The present invention relates to a program, an information processing apparatus, an information processing method, and an information management apparatus, and particularly, to a program, an information processing apparatus, an information processing method, and an information management apparatus capable of increasing the probability that the user views an advertisement.

### BACKGROUND ART

Conventionally, so-called search-linked advertisement distribution is generally performed, in which advertisements of commodities, services, and the like related to a keyword used in search of WEB pages, are displayed on an edge of a screen of the search result of WEB pages by a search server.

For example, when the user operates a mouse or the like to move the cursor to an advertisement and clicks the advertisement, a linked WEB page including information of commodities and services is displayed on the browser. This allows the advertisement requester, which has requested the provider that provides search services by use of a search server to post an advertisement, to have the user see the information of the commodities sold by the advertisement requester or of the provided services.

Patent Document 1: Japanese Patent Laid-Open No. 2006-79454

### DISCLOSURE OF THE INVENTION

### Problems to be Solved by the Invention

It is preferable for the advertisement requester, and also for the search service provider in terms of the improvement in the values of the search pages, that more users view the advertisement.

The present invention has been made in view of the circumstances, and the present invention is designed to increase the probability that the user views the advertisement.

### Means for Solving the Problems

An aspect of the present invention provides a program or an information processing method comprising steps of: acquiring information used to display link source information, in which links are set, in a list that includes, as items, information including the link source information; displaying the link source information and a list including, as items, advertisements acquired from a server, which distributes the advertisements, in a second area different from a first area that is a display area of information of the links; and displaying, in the first area, information of the link set to the link source information focused on the list or information of the link set to the advertisement focused on the list.

The advertisements acquired from the server, which distributes the advertisements, can be displayed in display fields wider than display fields of the link source information among the display fields of the items formed in the list.

When the focused item of the list is switched according to an operation in a certain direction by the user performed using an input apparatus, the focused item can be switched from an advertisement to the next item if the operation in the certain direction is performed by an amount greater than an amount necessary to switch the focus target from the link source information to the next item.

When the focused item on the list is automatically switched in order of the items arranged in a predetermined direction, the focused item can be switched from an advertisement to the next item if a time longer than a time for switching the focus target from the link source information to the next item has passed.

The information related to the links of the acquired link source information can be transmitted to the server which distributes the advertisements, information of the advertisements and control information as information designating display methods of the advertisements can be acquired, and the advertisements can be displayed on the list according to the methods designated by the control information.

WEB pages can be searched based on a keyword inputted by the user, the keyword can be transmitted to the server which distributes the advertisements, the information of the advertisements selected by the server based on the keyword can be acquired, and the advertisements acquired from the server can be displayed in the second area before the list including, as the link source information, the titles of the WEB pages obtained as a search result is displayed in the second area.

An aspect of the present invention provides an information processing apparatus comprising: acquisition means for acquiring information used to display link source information, in which links are set, in a list that includes, as items, information including the link source information; and display control means for displaying the link source information acquired by the acquisition means and a list including, as items, advertisements acquired from a server, which distributes the advertisements, in a second area different from a first area that is a display area of information of the links and for displaying, in the first area, information of the link set to the link source information focused on the list or information of the link set to the advertisement focused on the list.

Another aspect of the present invention provides an information management apparatus comprising distribution means for selecting advertisements based on information that is transmitted from the information processing apparatus and that is related to links of the link source information acquired by the information processing apparatus and for distributing information of the selected advertisements and control information as information designating display methods of the advertisements to the information processing apparatus.

In an aspect of the present invention, information used to display link source information, in which links are set, is acquired in a list that includes, as items, information including the link source information, and the link source information and a list including, as items, advertisements acquired from a server, which distributes the advertisements, are displayed in a second area different from a first area that is a display area of information of the links. Information of the link set to the link source information focused on the list or information of the link set to the advertisement focused on the list is displayed in the first area.

In another aspect of the present invention, advertisements are selected based on information that is transmitted from the information processing apparatus and that is related to links of the link source information acquired by the information processing apparatus, and information of the selected advertisements and control information as information designating display methods of the advertisements are distributed to the information processing apparatus.

### Advantage of the Invention

According to the present invention, the probability that the user views advertisement can be increased.

### BRIEF DESCRIPTION OF THE DRAWINGS

FIG. 1 is a diagram showing an example of configuration of an advertisement distribution system according to an embodiment of the present invention;

FIG. 2 is a diagram showing an example of a screen displayed on a display of a PC;

FIG. 3 is a diagram showing a specific example of display of a list;

FIG. 4 is a diagram showing an example of display of a list including advertisements as items;

FIG. 5 is a diagram showing another example of display of a list including advertisements as items;

FIG. 6 is a block diagram showing an example of functional configuration of the PC of FIG. 1;

FIG. 7 is a block diagram showing an example of functional configuration of an advertisement server of FIG. 1;

FIG. 8 is a flow chart explaining a process executed in the advertisement distribution system;

FIG. 9 is a flow chart explaining another process executed in the advertisement distribution system;

FIG. 10 is a diagram showing another example of display of a list; and

FIG. 11 is a diagram showing yet another example of display of a list.

### DESCRIPTION OF SYMBOLS

1 PC, 2 search server, 3 advertisement server, 4 WEB server, 5 network, 51 search unit, 52 advertisement acquisition unit, 53 list display control unit, 54 WEB page display control unit, 61 input unit, 62 database, 63 distribution unit

### BEST MODE FOR CARRYING OUT THE INVENTION

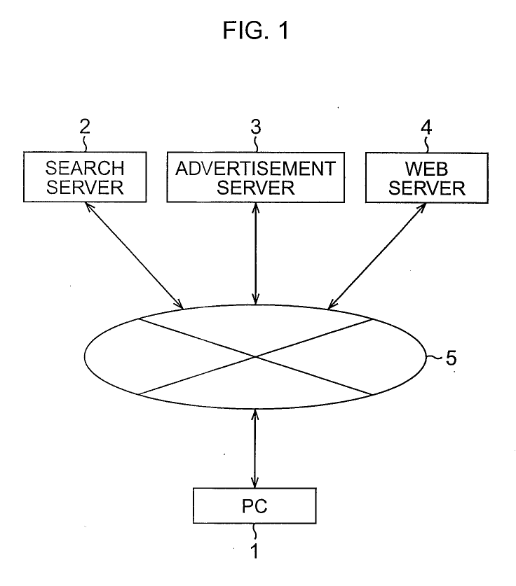

FIG. 1 is a diagram showing an example of configuration of an advertisement distribution system according to an embodiment of the present invention.

As shown in FIG. 1, the advertisement distribution system is constituted by a PC (Personal Computer) 1 as an information processing apparatus, a search server 2, an advertisement server 3 as an information management apparatus, and a WEB server 4 connected through a network 5 constituted by the Internet and the like. The numbers of the PCs and the servers are arbitrary.

The search server 2 is a server that provides a search function of WEB pages based on keywords and the like and is managed by a provider and the like that provides search services. The search server 2 searches WEB pages based on a search request transmitted from the PC 1 through the network 5 and transmits the search result. The search request from the PC 1 to the search server 2 includes a keyword, while the search result from the search server 2 to the PC 1 includes information, such as titles of searched WEB pages, search summaries (overviews), and URLs (Uniform Resource Locators).

The advertisement server 3 is a server that distributes advertisements. The advertisement server 3 selects advertisements based on, for example, information transmitted from the PC 1 through the network 5 and transmits (distributes) the information of the selected advertisement to the PC 1. The advertisement server 3 manages, in advance, information of advertisements related to, for example, commodities sold by or services provided by the advertisement requester which has requested the advertisement distribution provider as the manager of the advertisement server 3 for the distribution of advertisements.

The WEB server 4 is a server that manages WEB pages for posting texts and images as well as WEB contents such as videos and is managed by an Internet provider and the like. The WEB server 4 transmits, to the PC 1, HTML (Hyper Text Markup Language) files, WEB contents, and the like for displaying the WEB pages requested from the PC 1. Although cases in which the PC 1 handles WEB pages will be mainly described, the PC 1 executes similar processes in cases in which the PC 1 handles WEB contents.

The PC 1 is a device used by a user who browses WEB pages and is loaded with a WEB browser, such as Internet Explorer (trademark). When browsing WEB pages, the user, for example, launches the WEB browser to access the search server 2 to display the search page on the display. The user also operates a keyboard, for example, to input a keyword in an entry field of the search page to cause the search server 2 to search WEB pages related to the keyword.

The result of search by the search server 2 is transmitted to the PC 1 through the network 5, and the WEB browser displays the search result. The title of the WEB page, the search summary, the URL, and the like of each of a predetermined number, such as ten or one hundred, of WEB pages are arranged and displayed on the screen of the search result. The user checks the content of the title or the search summary and selects a predetermined WEB page to display the selected WEB page on the WEB browser to browse the WEB page.

The PC 1 is also loaded with software that works in conjunction with the WEB browser and that is for displaying a list including items, such as the titles of the WEB pages searched by the search server 2. For example, when the user selects a predetermined title from the titles displayed in the list by operating a mouse, the WEB browser acquires information of the selected WEB page from the WEB server 4, and the WEB page of the selected title is displayed.

Hereinafter, the software for displaying the list including items, such as the titles of the WEB pages, will be called software for list display as necessary. The software for list display can be prepared not only as a single application, but also in a plug-in form of the WEB browser.

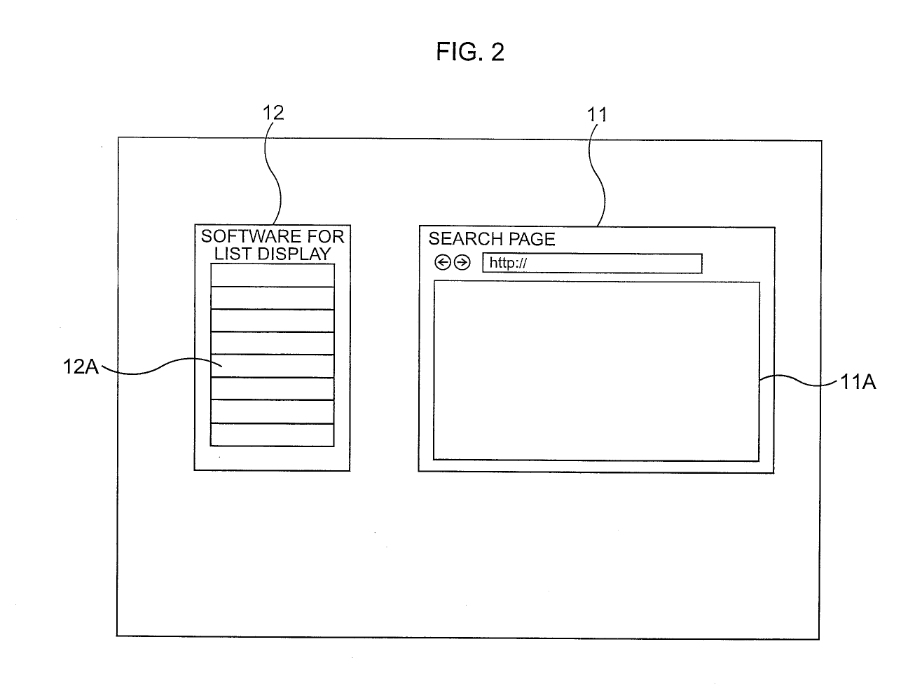

FIG. 2 is a diagram showing an example of a screen displayed on the display of the PC 1.

In the example of FIG. 2, a browser window 11 as a window of the WEB browser is displayed on the right side, and a list window 12 as a window of the software for list display is displayed on the left side.

Other than a URL display field displaying the URL of the WEB page, a button operated to return to the previous WEB page, a button operated to advance to the following WEB page, and the like are arranged at the upper part of the browser window 11, and a WEB page display unit 11A as a display area of WEB pages is arranged below. For example, just after the acquisition of the search result from the search server 2, the titles of the WEB pages, the search summaries, and the like described above are arranged and displayed on the WEB page display unit 11A. In addition to the search result of the WEB pages, the WEB page display unit 11A displays various WEB pages.

The list window 12 displays a list 12A. The list 12A displays the titles of the WEB pages of the search result as items. As described later, the list 12A may display advertisements as items. In this way, the list 12A is displayed in an area different from the WEB page display unit 11A.

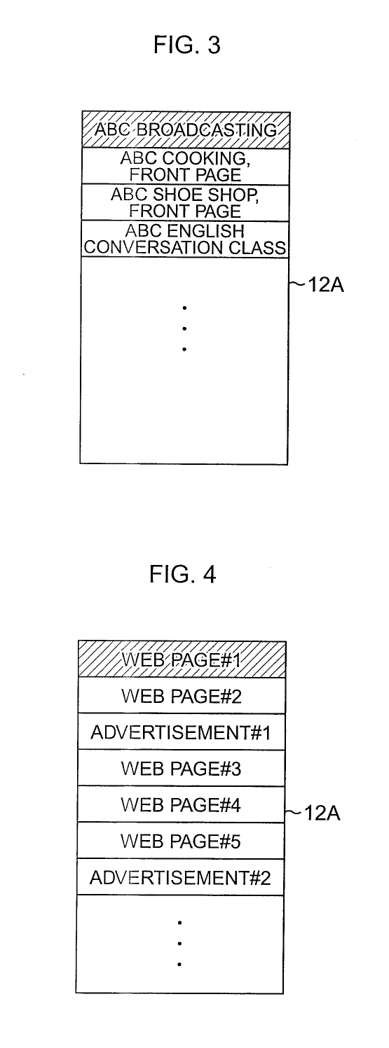

FIG. 3 is a diagram showing a specific example of display of the list 12A.

For example, when searching is performed based on a keyword “ABC”, the WEB page display unit 11A displays the titles and search summaries of the WEB pages related to “ABC”, and the list 12A displays the titles of the WEB pages as items as shown in FIG. 3. In the example of FIG. 3, “ABC Broadcasting”, “ABC Cooking, Front page”, “ABC Shoe Shop, Front Page”, “ABC English Conversation Class”, . . . are sequentially displayed from the top.

The user can operate the mouse and the like to move the cursor to a predetermined title to select the title by clicking and display the WEB page of the selected title on the WEB page display unit 11A. Links are set to the titles displayed in the list. In the example of FIG. 3, “ABC Broadcasting” is selected, and in this case, the WEB page display unit 11A displays the WEB page of “ABC Broadcasting”. Oblique lines in the field of “ABC Broadcasting” denote that the WEB page of “ABC Broadcasting” is focused by the selection and the like by the user.

A slide show display function of the WEB pages is installed in the software for list display. When the user instructs the start of the slide show display, the titles displayed in the list 12A are sequentially focused from the titles displayed above, and the WEB pages displayed on the WEB page display unit 11A are switched accordingly. The user designates the display interval of the WEB pages, such as two seconds, five seconds, and ten seconds.

For example, if the start of the slide show display is instructed when the list 12A of FIG. 3 is displayed, the WEB pages are displayed on the WEB page display unit 11A in the order of “ABC Broadcasting”, “ABC Cooking, Front Page”, “ABC Shoe Shop, Front Page”, “ABC English Conversation Class”, . . . . As a result, the user can check the contents of the WEB pages without selecting the WEB pages of the search result.

The WEB pages displayed on the WEB page display unit 11A can also be switched by a rotational operation of a wheel arranged in the mouse. For example, if the cursor is on the list window 12 (inside the list window 12), the title focused in the list 12A is switched every time the wheel is rotated by a predetermined amount, and the display of the WEB page display unit 11A is switched accordingly.

Therefore, the display of the WEB pages in the order of “ABC Broadcasting”, “ABC Cooking, Front Page”, “ABC Shoe Shop, Front Page”, “ABC English Conversation Class”, . . . as described above can also be realized by moving the cursor to the list window 12 and then continuing to rotate the wheel to the near side. When an operation of rotating the wheel to the far side is performed, the WEB pages are displayed in the order of “ABC English conversation class”, “ABC Shoe Shop, Front Page”, “ABC Cooking, Front Page”, and “ABC Broadcasting”, opposite of when the operation of rotating the wheel to the near side is performed.

A function of displaying the advertisement provided from the advertisement server 3 in the list is also installed in the software for list display. For example, when the result of search by the search server 2 is acquired, the software for list display of the PC 1 transmits identification information, such as URLs of the WEB pages included in the search result, to the advertisement server 3. When the URL of the WEB page established by the advertisement requester is included in the URLs transmitted from the PC1, the advertisement server 3 selects the advertisement requested by the advertisement requester and transmits the information of the selected advertisement to the PC 1. The information of the advertisement includes a text that serves as a caption of the advertisement, the URL of the WEB page including the detailed content of the advertisement, and the like.

The software for list display of the PC 1 that has received the information of the advertisements transmitted from the advertisement server 3 displays the advertisements acquired from the advertisement server 3 as items of the list, along with the titles of the WEB pages searched by the search server 2.

FIG. 4 is a diagram showing an example of display of the list 12A including advertisements as items.

In the example of FIG. 4, “WEB Page #1” and “WEB Page #2” are sequentially displayed from the top, and “Advertisement #1” is displayed in a field below as an item of the list 12A. In this case, the title of the WEB page is indicated by a number, such as “WEB Page #”, and the advertisement is indicated by a number, such as “Advertisement #”. “WEB Page #1” and “WEB Page #2” are the titles of the WEB pages searched by the search server 2, and “Advertisement #1” is the advertisement transmitted from the advertisement server 3.

In the example of FIG. 4, “WEB Page #3”, “WEB Page #4”, and “WEB Page #5”, which are the titles of the WEB pages searched by the search server 2, are displayed below “Advertisement #1”, and “Advertisement #2”, which is an advertisement transmitted from the advertisement server 3, is displayed in the field below those.

If the start of the slide show display is instructed in the state of FIG. 4 in which “WEB Page #1” is focused, or if an operation of rotating the wheel to the near side in the state in which the cursor is moved to the list window 12, “WEB Page #2”, “Advertisement #1”, “WEB Page #3”, “WEB Page #4”, “WEB Page #5”, “Advertisement #2”, . . . are sequentially focused, and the focused WEB pages are displayed on the WEB page display unit 11A. More specifically, “WEB Page #1” and “WEB Page #2” are sequentially displayed on the WEB page display unit 11A, and then a WEB page linked from “Advertisement #1” and including the detailed content of “Advertisement #1” is displayed. “WEB Page #3”, “WEB Page #4”, and “WEB Page #5” are sequentially displayed, and then the WEB page linked from “Advertisement #2” is displayed.

As a result, the advertisement distribution provider can surely show the advertisement to the user who is browsing WEB pages using the software for list display. For example, in the case of a banner advertisement displayed on the edge of the WEB page of the search result, the linked WEB page is not displayed unless the user clicks the banner advertisement. However, if the advertisement is displayed as an item of a list, and the WEB page is displayed in conjunction with focusing of the item, WEB pages linked from the advertisements are displayed on the WEB page display unit 11A, similar to other WEB pages in which the titles are displayed in the list.

The advertisement distribution provider can conduct business of charging fees from the advertisement requester and showing the advertisement to the user browsing the WEB page using the software for list display.

The advertisements displayed as “Advertisement #1” and “Advertisement #2” on the list 12A may be text advertisements or AdSense-like advertisements, or may be advertisements in a banner format, advertisements in a pop-up format, or rich media advertisements including still images, videos, and the like. As described later, display locations and the like of the advertisements on the list 12A are determined in accordance with information transmitted from the advertisement server 3.

In the description above, although the advertisement server 3 selects the advertisement requested by the advertisement requester if the URLs of the WEB pages of the search result include the URL of the WEB page established by the advertisement requester, the advertisement may be selected by any method, such as by random selection.

Instead of the PC 1 transmitting the URLs, keywords and the like included in the WEB pages of the search result may be transmitted as the identification information of the WEB pages of the search result, and the advertisement server 3 may select advertisements based on the keywords. For example, if the advertisements are managed in association with keywords, advertisements associated with the same keywords as the keywords transmitted from the PC 1 are selected, and the information is transmitted to the PC 1.

In the description above, although the vertical width of the display field of the advertisement and the vertical width of the display field of the title of the WEB page among the fields formed in the list are the same, the widths may be different.

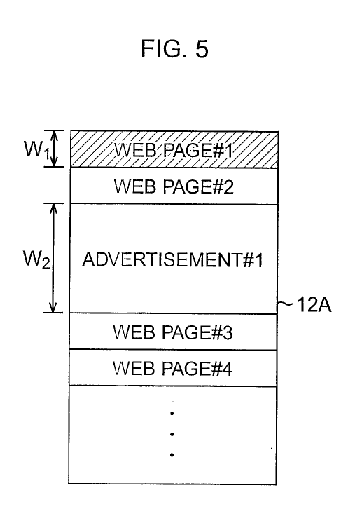

FIG. 5 is a diagram showing another example of display of the list 12A.

In the example of FIG. 5, “WEB Page #1” and “WEB Page #2” are sequentially displayed from the top, and “Advertisement #1” is displayed in the field below, as in the example shown in FIG. 4. However, a vertical width W₂ in the display field of “Advertisement #1” is wider than a width W₁ which is a standard vertical width in the display field of the title of the WEB page.

To switch the focused item by a rotational operation of the wheel when such a list is displayed, more rotation is required to switch the focus target from an advertisement to the next item than to switch the focus target from the title of a WEB page to the next item. For example, if the width W₂ of FIG. 5 is three times as large as the width W₁, the user needs to rotate the wheel three times more to switch the focus target to the next item “WEB page #3” when “Advertisement #1” is focused than to switch the focus target from “WEB Page #1” to “WEB Page #2”.

When the focused item is automatically switched by the slide show display, the time to switch the focus target from an advertisement to the next item is longer than the time to switch the focus target from the title of a WEB page to the next item. For example, if the width W₂ of FIG. 5 is three times as large as the width W₁, “Advertisement #1” is focused for nine seconds if the time to focus the title of a normal WEB page is three seconds, and the WEB page linked from “Advertisement #1” is displayed on the WEB display unit 11A during the nine seconds.

Not only the display location of an advertisement in the list, but also the vertical width of the field of the advertisement is designated by, for example, the information transmitted from the advertisement server 3.

This allows the advertisement distribution provider to show the user a specific advertisement for a long time. Furthermore, the method of displaying the advertisement can be changed according to the amount of money received from the advertisement requester as a customer, such as by displaying the advertisement of the advertisement requester that has paid more amount of money in a wide display field and displaying the advertisement requested from the advertisement requester that has paid only a small amount of money in a display field in the same size as the titles of the WEB pages.

The process of the PC 1 and the like for displaying the list described above and the like will be described later with reference to a flow chart.

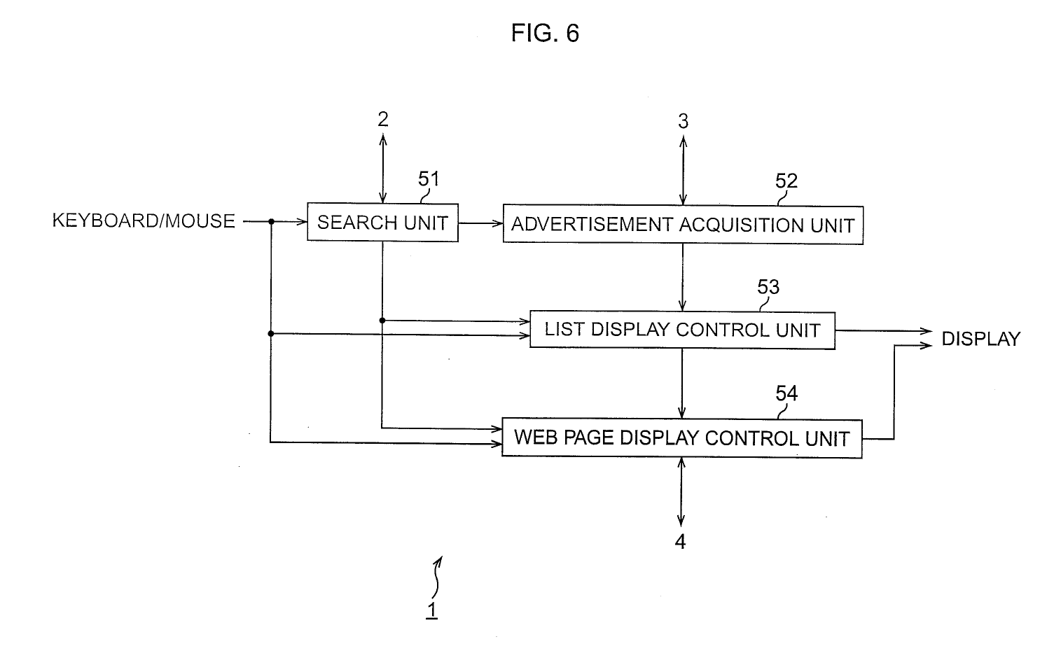

FIG. 6 is a block diagram showing an example of functional configuration of the PC 1.

The CPU (Central Processing Unit) of the PC 1 executes the WEB browser and the software for list display to realize at least part of the function units shown in FIG. 6. As shown in FIG. 6, the PC 1 realizes a search unit 51, an advertisement acquisition unit 52, a list display control unit 53, and a WEB page display control unit 54.

The search unit 51 acquires a keyword in accordance with an operation of the user performed by using a keyboard or a mouse and controls a network interface not shown to access the search server 2 to request searching of WEB pages. The search unit 51 acquires the information of the search result of WEB pages from the search server 2 and outputs the acquired information to the advertisement acquisition unit 52, the list display control unit 53, and the WEB page display control unit 54.

The advertisement acquisition unit 52 transmits information related to the search result, such as the URLs of the WEB pages, included in the information supplied from the search unit 51 to the advertisement server 3 to request transmission of an advertisement. The advertisement acquisition unit 52 acquires the information of the advertisement transmitted from the advertisement server 3 according to the request and control information designating methods of display of the advertisement and outputs the acquired information to the list display control unit 53.

The list display control unit 53 inserts the advertisement supplied from the advertisement acquisition unit 52 to the list of the titles of the WEB pages included in the information supplied from the search unit 51 in accordance with the designation by the control information to display the list as shown in FIGS. 4 and 5 including the advertisement and the titles of the WEB pages as items. The list display control unit 53 also controls the display of the displayed list in accordance with an operation by the user and switches the focused item. The list display control unit 53 outputs the information of the focused item to the WEB page display control unit 54.

The WEB page display control unit 54 displays the search result of WEB pages on the WEB page display unit 11A based on the information supplied from the search unit 51. The WEB page display control unit 54 also specifies the focused item based on the information supplied from the list display control unit 53 and acquires information, such as an HTML file for displaying the searched WEB pages or the WEB pages linked from the advertisement, from the WEB server 4 to display the WEB pages on the WEB page display unit 11A. The WEB page display control unit 54 appropriately controls the display of the WEB pages in accordance with the operation by the user.

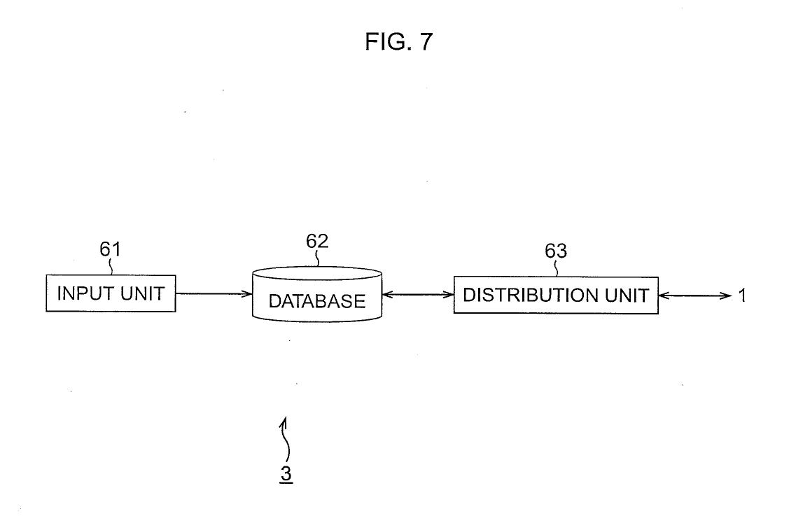

FIG. 7 is a block diagram showing an example of functional configuration of the advertisement server 3.

The CPU of the advertisement server 3 executes a predetermined program to realize at least part of the function units shown in FIG. 7. As shown in FIG. 7, the advertisement server 3 realizes an input unit 61, a database 62, and a distribution unit 63.

The input unit 61 acquires information of an advertisement in accordance with input by the manager or the like of the advertisement server 3 and stores the acquired information of the advertisement in the database 62. The information of the advertisement includes texts and images displayed in the display fields of the list, URLs of the linked WEB pages, and the like.

The input unit 61 also acquires control information designating methods of display of the advertisements in accordance with input by the manager or the like of the advertisement server 3 and stores the acquired control information in the database 62 in association with the information of advertisements. The control information includes information designating in which display fields in the list the advertisements will be displayed, information designating the sizes of the vertical widths of the fields for displaying the advertisements, and the like.

The database 62 associates and stores the information of the advertisement and the control information acquired from the input unit 61. Identification information of the advertisement requester that requests the distribution of the advertisement and the like is also associated with the information of the advertisement.

The distribution unit 63 receives the information related to the WEB pages transmitted from the PC 1 and searched by the search server 2 and selects an advertisement to be distributed to the PC 1.

As described, for example, if URLs are transmitted from the PC 1 as information related to the WEB pages searched by the search server 2, the distribution unit 63 determines whether the URL of the WEB page established by the advertisement requester is included in the URLs. The distribution unit 63 manages the URL and the like of the WEB page provided by the advertisement requester and established by the advertisement requester. If the distribution unit 63 determines that the URL of the WEB page established by the advertisement requester is included in the received URLs, the distribution unit 63 reads out the information of the advertisement requested from the advertisement requester and the control information designating the method of display of the advertisement from the database 62 and transmits the read out information to the PC 1 through the network 5.

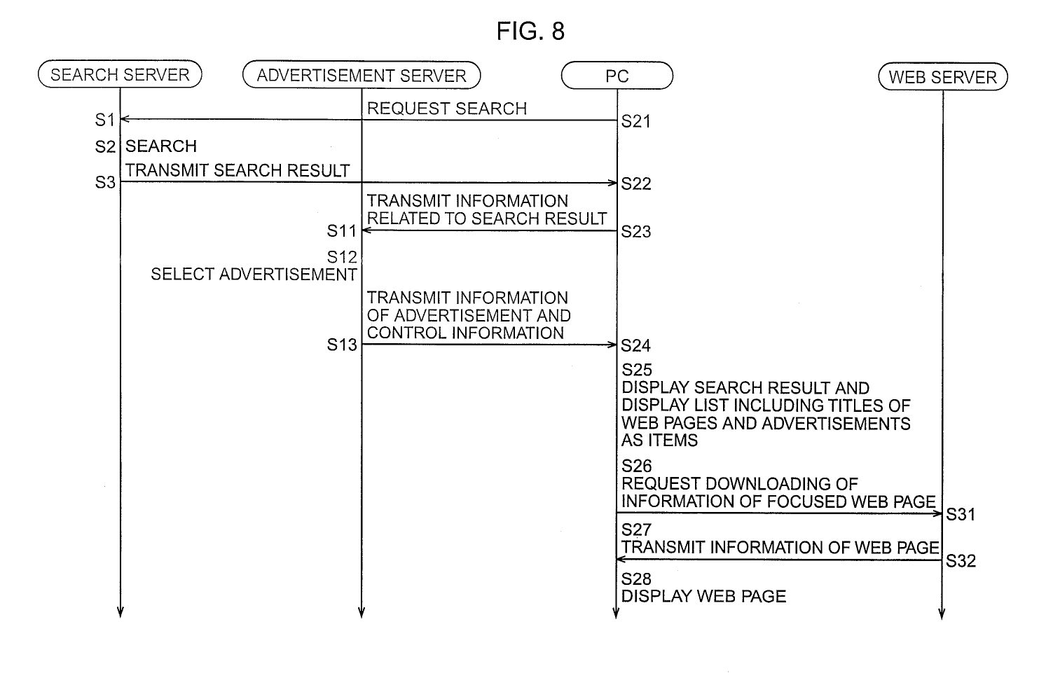

The process executed in the advertisement distribution system of FIG. 1 including the apparatuses configured as described above will be described with reference to the flow chart of FIG. 8. The search server 2 is configured to realize a search function, and the WEB server 4 is configured to manage HTML files and the like for displaying WEB pages by the WEB browser and to provide the HTML files and the like to the PC 1.

In step S21, the search unit 51 of the PC 1 acquires a keyword in accordance with an operation by the user and accesses the search server 2 to request searching of WEB pages.

The search server 2 receives the request from the PC1 in step S1 and searches WEB pages in step S2. In step S3, the search server 2 transmits information of the WEB pages, such as titles, search summaries, and URLs, to the PC 1 as a search result.

In step S22, the search unit 51 of the PC 1 receives the information transmitted from the search server 2 as the search result and outputs the received information to the advertisement acquisition unit 52, the list display control unit 53, and the WEB page display control unit 54.

In step S23, the advertisement acquisition unit 52 transmits the information related to the WEB pages of the search result to the advertisement server 3 and requests transmission of an advertisement.

The distribution unit 63 of the advertisement server 3 receives the information related to the WEB pages transmitted from the PC 1 in step S11 and selects an advertisement in step S12.

In step S13, the distribution unit 63 reads out the information of the selected advertisement and the associated control information from the database 62 and transmits the read information to the PC 1.

In step S24, the advertisement acquisition unit 52 of the PC 1 receives the information transmitted from the advertisement server 3 and outputs the received information to the list display control unit 53.

In step S25, the WEB page display control unit 54 causes the WEB page display unit 11A to display the search result of WEB pages based on the information supplied from the search unit 51. The list display control unit 53 causes the list window 12 to display the list including the advertisements and the titles of the WEB pages as items. The user can start the slide show display or perform a rotational operation of the wheel to start browsing the searched WEB pages and the WEB page linked from the advertisement. The information of the focused WEB page in the list is supplied from the list display control unit 53 to the WEB page display control unit 54.

In step S26, the WEB page display control unit 54 accesses the WEB server 4 to request downloading of the information of the focused WEB page.

The WEB server 4 receives the request from the PC 1 in step S31 and transmits the requested information of the WEB page to the PC 1 in step S32.

The WEB page display control unit 54 of the PC 1 receives the information transmitted from the WEB server 4 in step S27 and causes the WEB page display unit 11A to display the WEB page in step S28. The process of steps S26 to S28 is repeated in PC 1 every time the focused item is switched.

Based on the process described above, the advertisement distribution provider can surely show the advertisement to the user browsing the WEB pages using the software for list display.

Although different apparatuses search the WEB pages and distribute the advertisement in the description above, the same device may search the WEB pages and distribute the advertisement. In that case, the same apparatus includes a configuration for realizing the search function in addition to the configuration of the advertisement server 3 shown in FIG. 7. In that case, the information of advertisement displayed in the list is transmitted to the PC 1 along with the search result of WEB pages.

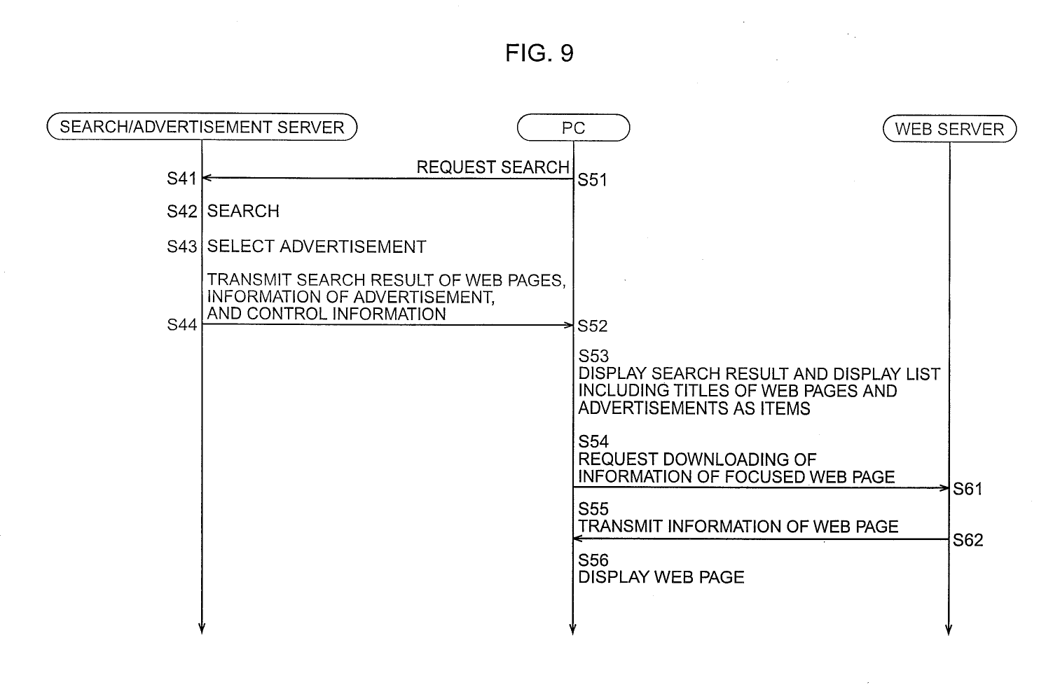

A process when the same apparatus searches the WEB pages and distributes the advertisement will be described with reference to a flow chart of FIG. 9.

The process of FIG. 9 is basically the same process as the process of FIG. 8, except that one apparatus executes the process executed by the search server 2 and the process executed by the advertisement server 3. The repeated description will be omitted as necessary. The apparatus that searches WEB pages and distributes advertisements will be described as a search/advertisement server.

In step S51, the search unit 51 of the PC 1 accesses the search/advertisement server to request searching of WEB pages.

The search/advertisement server receives the request from the PC 1 in step S41 and searches WEB pages in step S42. In step S43, the search/advertisement server selects advertisements to be distributed to the PC 1 in the same way as the distribution unit 63 of FIG. 7 based on the searched WEB pages.

In step S44, the search/advertisement server transmits the information of the selected advertisement and the associated control information to the PC 1 along with the search result of the WEB pages.

In step S52, the search unit 51 of the PC 1 receives the search result of WEB pages transmitted from the search/advertisement server and outputs the received information to the list display control unit 53 and the WEB page display control unit 54. The advertisement acquisition unit 52 receives the information of the advertisement and the control information transmitted from the search/advertisement server and outputs the received information to the list display control unit 53.

In step S53, the WEB page display control unit 54 causes the WEB page display unit 11A to display the search result of WEB pages based on the information supplied from the search unit 51. The list display control unit 53 causes the list window 12 to display a list including the titles of the advertisements and the WEB pages as items.

In step S54, the WEB page display control unit 54 accesses the WEB server 4 and requests downloading of the information of the focused WEB page.

The WEB server 4 receives the request from the PC 1 in step S61 and transmits the requested information of the WEB page to the PC 1 in step S62.

The WEB page display control unit 54 of the PC 1 receives the information transmitted from the WEB server 4 in step S55 and causes the WEB page display unit 11A to display the WEB page in step S56. The process of steps S54 to S56 is repeated in the PC 1 every time the focused item is switched.

In this way, as the advertisement distribution provider provides the search service, the advertisement distribution provider can control the search result so that the WEB page established by the advertisement requester is easily selected as the search result. Since the WEB page established by the advertisement requester is more often selected as the search result, the probability that the requested advertisement is displayed in the list can also be increased.

Although advertisements are displayed as items in the list in the description above, the advertisements may be displayed by other methods based on the information transmitted from the server side managed by the advertisement distribution provider.

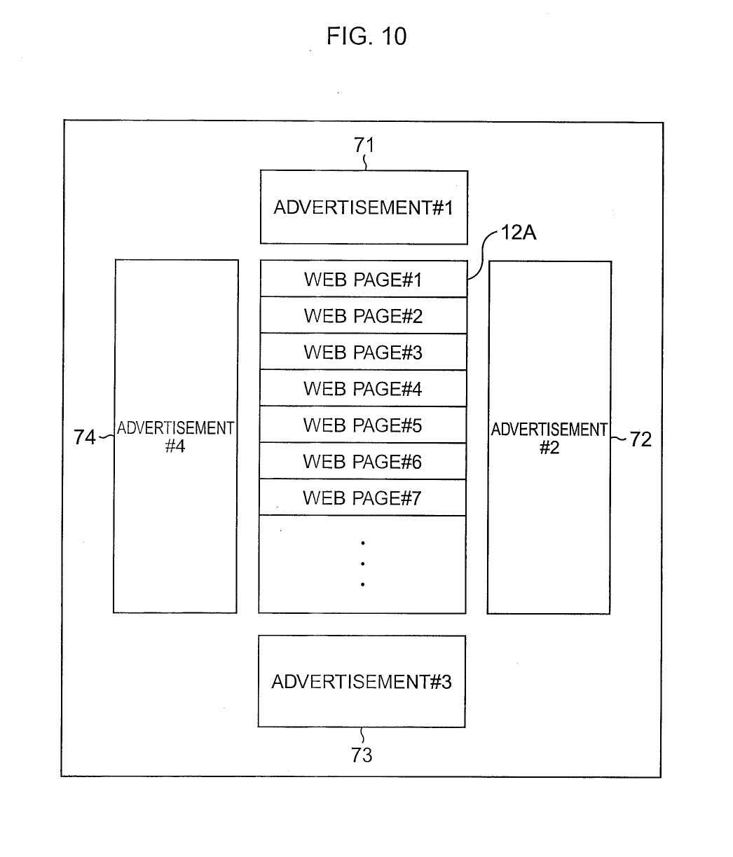

FIG. 10 is a diagram showing another example of display of the list 12A.

In the example of FIG. 10, the list 12A including the titles of WEB pages as items is displayed, and Advertisements #1 to #4 are displayed in areas 71 to 74, respectively, around the list 12A. The advertisements #1 to #4 are advertisements selected by the advertisement server 3 based on the search result, and the display locations are designated by the control information transmitted from the advertisement server 3.

The user can display the WEB page linked from the Advertisement #1 on the WEB page display unit 11A by, for example, moving the cursor to the area 71 and clicking the area 71.

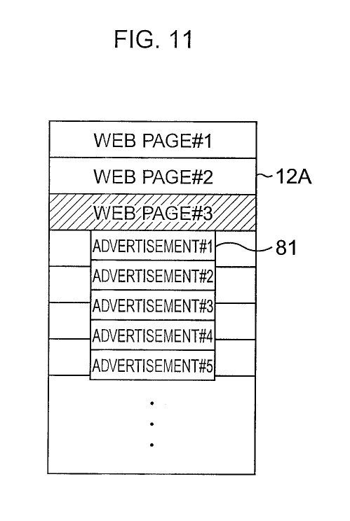

FIG. 11 is a diagram showing yet another example of display of the list 12A.

In the example of FIG. 11, the list 12A including the titles of the WEB pages as items is displayed, and a small list 81 is displayed on top of the list 12A. For example, the small list 81 is displayed below the display field of “WEB Page #3” in accordance with the control information transmitted from the advertisement server 3 when “WEB Page #3” is focused in the list 12A by a wheel operation and the like.

The small list 81 is a list including advertisements as items, and Advertisements #1 to #5 are displayed in the example of FIG. 11. The advertisements displayed as items in the small list 81 depend on the focused WEB page, such as advertisements of commodities and the like sold by the advertisement requester establishing “WEB Page #3”.

For example, if an operation of rotating the wheel to the near side is performed when the cursor is moved to the small list 81, the Advertisements #1 to #5 displayed in the small list 81 are sequentially focused, and the WEB pages linked from the advertisements are displayed on the WEB page display unit 11A. If an operation of rotating the wheel to the near side is performed when the cursor is removed from the small list 81 and is on the list 12A, the focus target is switched to the item in one display field below “WEB Page #3”, and the display of the small list 81 is deleted.

The small list 81 may be automatically displayed at a location different from the location on the list 12A when “WEB page #3” is focused from the list 12A and displayed on the WEB page display unit 11A.

Instead of the display of the advertisements in the small list 81 as shown in FIG. 11, a GUI (Graphical User Interface) in a tree structure may display the advertisements. For example, when a predetermined WEB page is focused from the list 12A, a list of advertisements of commodities and the like sold by the advertisement requester establishing the WEB page is displayed in a tree structure. When a predetermined advertisement is selected from the advertisements displayed in the tree structure, the WEB page linked from the selected advertisement are displayed on the WEB page display unit 11A.

Instead of the transmission of information of the advertisements from the advertisement server 3, data of the list including the advertisements and the like defined by XML (eXtensible Markup Language) or the like may be placed in a specific directory of the WEB server 4, and when the PC 1 displays a predetermined WEB page, the directory may be automatically accessed, and the data of the list including the advertisements and the like may be acquired from the WEB server 4 without the involvement of the advertisement server 3. In that case, the HTML file for displaying the WEB pages includes information indicating the directory as a destination.

The PC 1 may output music or announce when an advertisement in the list is focused.

Although the list is displayed in a window different from the window of the WEB browser in the description above, the list may be incorporated into the frame of the WEB browser and displayed. The software for list display may be provided in a form of gadget or widget.

Although the display location of the advertisement is designated by the control information transmitted from the advertisement server 3, the PC 1 may randomly select a predetermined display field and display the advertisement at the selected location when the advertisement is displayed as an item of the list.

Instead of the acquisition, from the advertisement server 3, of the advertisement to be displayed in the list upon the acquisition of the search result, the PC 1 may access the advertisement server 3 when the focus target is switched in the list to acquire and display the advertisement related to the WEB page focused now.

Although the information displayed in the list as items is titles of the WEB pages listed as the search result, the titles of the linked WEB pages included in the WEB pages of the links may be displayed as the items if the WEB pages of the links are prepared in a predetermined server and the information of the WEB pages is acquired. In this case, the linked WEB page is displayed on the WEB page display unit 11A in response to the selection of the title from the list.

Titles of RSS contents collected by an RSS reader and written titles posted on a bulletin board may be displayed as items. Links are set to the titles, and when a link is selected from the list, the linked RSS contents and the writings are displayed in an area different from the list.

Although the item focused on the list is switched in accordance with the rotational operation of the wheel of the mouse in the description above, the item may be switched in accordance with a rotational operation of the periphery of a circular touch pad in a certain direction by fingertip, or the item may be switched in accordance with the direction of tracing of a fingerprint authentication device by fingertip if the fingerprint authentication device is arranged on the PC 1. In other words, the item can be switched in accordance with operations to various input apparatuses capable of switching the target by continuing the operation in a predetermined direction.

The selection method of advertisements by the distribution unit 63 of the advertisement server 3 is not limited to the method executed based on the URLs of the WEB pages of the search result transmitted from the PC 1. For example, if the PC 1 is designed to transmit the information related to the browsing speed (speed of switching the focus target on the list) of WEB pages by the user, the advertisement can be selected in accordance with the browsing speed.

An advertisement with characters larger than a standard size is displayed on the list if the browsing speed is faster than a threshold, and an advertisement with characters in the standard size is displayed on the list if the browsing speed is slower than the threshold. In this way, the advertisement can be effectively presented regardless of the speed of the user browsing WEB pages.

One or a plurality of advertisements transmitted from the advertisement server 3 may be displayed in the list window 12 before displaying the list based on the search result of WEB pages after acquiring the search result. For example, the display of the advertisement on the entire area for displaying the list can surely show the advertisement to the user.

The advertisement is displayed until the completion of the list, and when the list is completed, the completed list is displayed in the list window 12 in place of the advertisement. The advertisement displayed in the entire area for displaying the list may be deleted in accordance with the display of the list or may be reduced at a predetermined location for continuous display.

The PC 1 may select an advertisement related to a keyword inputted by the user to be used in searching of WEB pages and may display the selected advertisement.

The series of processes described above may be executed by hardware or may be executed by software. When the series of processes are executed by software, programs constituting the software are, for example, installed from a program recording medium to a computer incorporated into dedicated hardware or to a general-purpose personal computer capable of executing various functions by installing various programs.

The programs are recorded in a removable medium, such as an optical disk and a memory card, or provided through a wired or wireless transmission medium, such as a local area network, Internet, and digital broadcasting, and are installed in a personal computer.

The programs executed by the computer may be programs for executing the processes in a time-series manner in the order of description in the present specification, or may be programs for executing the processes in parallel or at necessary timing such as when the programs are invoked. The programs can be installed not only to the personal computer, but also to various information processing apparatuses, such as a PDA (Personal Digital Assistance), a cell phone, and a gaming device.

The embodiment of the present invention is not limited to the embodiment described above, and various changes can be made without departing from the scope of the present invention.

1. A program causing a computer to execute a process comprising steps of:
displaying a list displaying, in fields, link source information, in which links are set, and advertisements, in which links acquired from an advertisement server that distributes the advertisements are set, in a second area different from a first area that is a display area of the information of the links to set locations, in the list, of the advertisement fields displaying the advertisements and widths of the advertisement fields in the same direction as a direction that the fields are arranged to locations and widths designated by information transmitted from the advertisement server;
displaying, in the first area, information of the link set to the link source information focused on the list or information of the link set to the advertisement focused on the list; and
when the width of the advertisement fields is wider than the width of the fields displaying the link source information, and a focus target among the link source information and the advertisements displayed in the fields of the list is switched in accordance with an operation to an input apparatus in a certain direction by the user, switching the focus target from the advertisement to the next item if the operation in the certain direction is performed by an amount greater than an amount required to switch the focus target from the link source information to the next item.

2. The program according to claim 1, wherein
when the focus target is automatically switched in the order of arrangement in the list, the focus target is switched from the advertisement to the next item when a time longer than a time for switching the focus target from the link source information to the next item has passed.

3. The program according to claim 1 or 2, further comprising a step of:
transmitting the information related to the links of the acquired link source information to the advertisement server and acquiring information of the advertisements to be displayed in the list and control information as information designating display methods of the advertisements.

4. The program according to claim 1, 2 or 3, wherein
WEB pages are searched based on a keyword inputted by the user, and
the advertisements acquired from the advertisement server are displayed in the second area before the list including, as the link source information, the titles of the WEB pages obtained as a search result is displayed in the second area.

5. An information processing apparatus comprising a display control means, the display control means configured to:
display a list displaying, in fields, link source information, in which links are set, and advertisements, in which links acquired from an advertisement server that distributes the advertisements are set, in a second area different from a first area that is a display area of the information of the links to set locations, in the list, of the advertisement fields displaying the advertisements and widths of the advertisement fields in the same direction as a direction that the fields are arranged to locations and widths designated by information transmitted from the advertisement server;
display, in the first area, information of the link set to the link source information focused on the list or information of the link set to the advertisement focused on the list; and
when the width of the advertisement fields is wider than the width of the fields displaying the link source information, and a focus target among the link source information and the advertisements displayed in the fields of the list is switched in accordance with an operation to an input apparatus in a certain direction by the user, switch the focus target from the advertisement to the next item if the operation in the certain direction is performed by an amount greater than an amount required to switch the focus target from the link source information to the next item.

6. An information processing method comprising steps of:
displaying a list displaying, in fields, link source information, in which links are set, and advertisements, in which links acquired from an advertisement server that distributes the advertisements are set, in a second area different from a first area that is a display area of the information of the links to set locations, in the list, of the advertisement fields displaying the advertisements and widths of the advertisement fields in the same direction as a direction that the fields are arranged to locations and widths designated by information transmitted from the advertisement server;
displaying, in the first area, information of the link set to the link source information focused on the list or information of the link set to the advertisement focused on the list; and
when the width of the advertisement fields is wider than the width of the fields displaying the link source information, and a focus target among the link source information and the advertisements displayed in the fields of the list is switched in accordance with an operation to an input apparatus in a certain direction by the user, switching the focus target from the advertisement to the next item if the operation in the certain direction is performed by an amount greater than an amount required to switch the focus target from the link source information to the next item.

7. (canceled)

8. (canceled)

9. (canceled)
